(19) United States
(12) Patent Application Publication
(10) Pub. No.: US 2002/0111139 A1
(43) Pub. Date: Aug. 15, 2002

(54) Data distribution system and mobile data communication device

(76) Inventors: Mika Nishiyama, Yokohama (JP); Hiroshi Shimizu, Yokohama (JP); Shigeyuki Sudo, Yokohama (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/975,951

(22) Filed: Oct. 15, 2001

(30) Foreign Application Priority Data
Feb. 14, 2001 (JP) 2001-037229

(51) Int. Cl. H04B 5/00

(52) U.S. Cl. 455/41; 455/422

(57) ABSTRACT

The object of the present invention is to provide a data distribution system that is capable of distributing to a mobile communication terminal at a specific location information suited for the location, e.g., guide information, and that is capable of allowing anyone to easily and freely access information.

In order to achieve this object, the present invention provides a data distribution system communicating with a mobile data communication device capable of obtaining current position information indicating a current position. The present invention is equipped with data communication means sending and receiving data to and from the mobile data communication device and means for storing information storing area position information indicating a position of a specific area and information associated with the specific area. Control is provided so that, if the mobile data communication device is located in the specific area, information associated with the specific area is sent to the mobile data communication device via data communication means.

### BACKGROUND OF THE INVENTION

The present invention relates to a data distribution system and a mobile data communication device. More specifically, the present invention relates to a data distribution technology for distributing information to users in specific locations.

Zoos, aquariums, and the like may be equipped with guide machines that allow users to listen to descriptions of animals and the like. Museums may rent out guide tapes relating to the exhibits or may have personal computers or the like installed near the entrance or exit to allow users to search for descriptions of exhibits.

### SUMMARY OF THE INVENTION

However, with guide machines at zoos, the user can often only operate one button for starting the guide program or the like. This prevents individual users to freely use the guide. Also, with personal computers installed near entrances, the user cannot see the descriptions while viewing the actual exhibits. Furthermore, since the guide machines at zoos and the guide tape rentals at museums often involve a fee, the user must pay a fee in addition to the entry fee. Also, the guide service provider at zoos, museums, or the like simply provide guide services and cannot obtain information about the users receiving services.

Meanwhile, with the dramatic increase in popularity and performance of mobile phones, there is a demand for mobile phones equipped with new features and new services based on these features.

The object of the present invention is to provide a data distribution system that distributes information to mobile communication terminals, e.g., mobile phones, located at specific locations. Another object of the present invention is to allow anyone to easily and freely view information and to reduce the fee burden on the user. Yet another object of the present invention is to provide a data distribution system that allows the service provider to obtain information about users who receive services.

In order to achieve the objects described above, a data distribution system according to the present invention communicates with a mobile data communication device capable of obtaining current position information indicating a current position. This system uses the following elements. The system includes: data communication means for sending and receiving data to and from the mobile data communication device; means for storing area position information indicating a position of a specific area and information associated with the specific area; means for discriminating whether or not the mobile data communication device is in the specific area based on the current position information sent from the mobile data communication device. Also, means for controlling provides control so that, in case the mobile data communication device is located in the specific area, information associated with the specific area is sent to the mobile data communication device via said data communication means. Alternatively, means for controlling provides control so that, in case data communication means receives information indicating that the mobile data communication device is in the specific area, information associated with the specific area is sent to the mobile data communication device via said data communication means.

Also, the service provider performing data distribution using this system can set up a fee for entering a specific area. The user pays the fee to the service provider and enters the specific area. Using the fee received from the user, the service provider pays for at least part of the fee charged when mobile data communication means receives information.

### BRIEF DESCRIPTION OF THE DRAWINGS

FIG. 1 is a drawing of the structure of a data distribution system according to a first embodiment of the present invention.

FIG. 2 is a drawing for the purpose of describing sample screens displayed when a data distribution service according to a first embodiment of the present invention is implemented for a guide service in a zoo.

FIG. 3 is a drawing for the purpose of describing a sample data format stored in information storing means in a first embodiment of the present invention.

FIG. 4 is a flowchart showing the flow of operations performed by information controlling means in a first embodiment of the present invention.

FIG. 5 is a block diagram showing a section of the internal structure of mobile data communication means according to a first embodiment of the present invention.

FIG. 6 is a drawing for the purpose of describing a billing system that can be implemented in a first embodiment of the present invention.

FIG. 7 is a drawing for the purpose of describing sample screens displayed when a data distribution service according to a first embodiment of the present invention is implemented in a museum guide service.

FIG. 8 is a drawing for the purpose of describing sample screens displayed when a data distribution service according to a first embodiment of the present invention is implemented in a department store guide service.

FIG. 9 is a drawing of the structure of a data distribution system according to a second embodiment of the present invention.

FIG. 10 is a drawing for the purpose of describing a sample data format stored in information storing means in a second embodiment of the present invention.

FIG. 11 is a drawing showing the structure of a data distribution system according to a third embodiment of the present invention.

FIG. 12 is a drawing for the purpose of describing sample screens for receiving personal information from users according to a third embodiment of the present invention.

FIG. 13 is a flowchart showing the flow of operations performed by information controlling means according to a third embodiment of the present invention.

FIG. 14 is a drawing showing the structure of a data distribution system according to a fourth embodiment of the present invention.

FIG. 15 is a drawing for the purpose of describing sample user information stored in user information storing means according to a fifth embodiment of the present invention.

FIG. 16 is a flowchart illustrating the flow of operations performed by information controlling means according to a fifth embodiment of the present invention.

FIG. 17 is a drawing for the purpose of describing sample screens displayed when advertisement information is sent to a user according to a fifth embodiment of the present invention.

FIG. 18 is a drawing for the purpose of describing sample screens for selecting an information display format and sample screens displaying information in corresponding display formats according to a sixth embodiment of the present invention.

### DESCRIPTION OF THE PREFERRED EMBODIMENTS

The following is a description of the embodiments of the present invention, with references to the drawings.

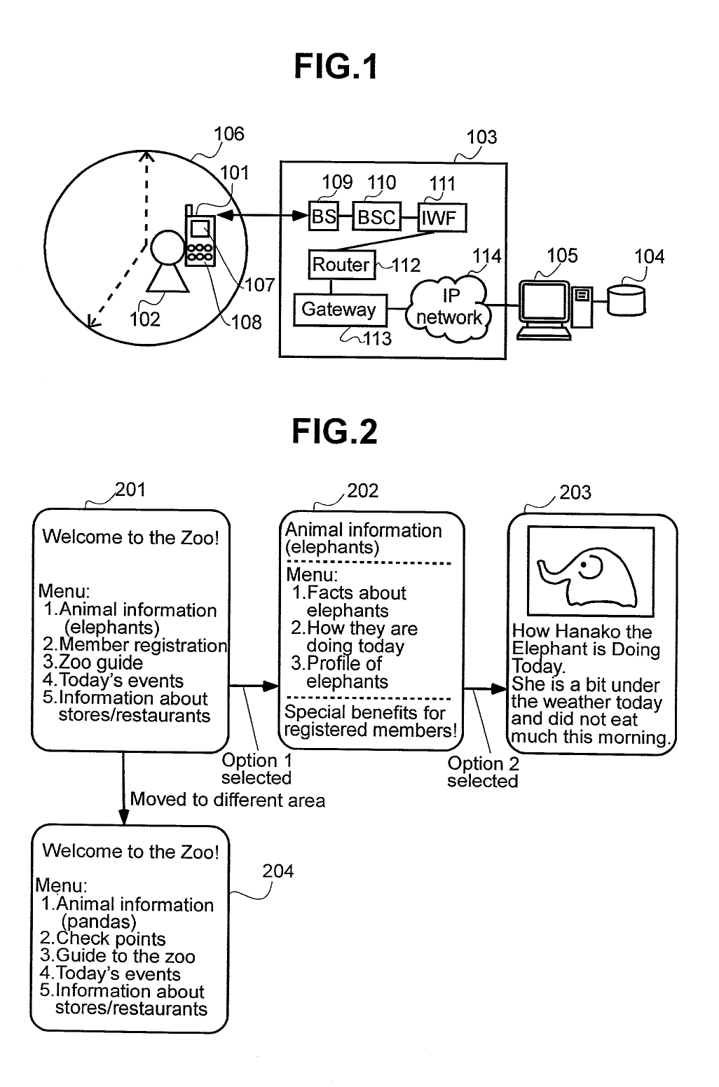

FIG. 1 is a drawing showing the structure of a data distribution system according to a first embodiment of the present invention. Mobile data communication means 101 can move around together with a user 102. This mobile data communication means retrieves position information for the current position and transmits and receives data containing the position information. Data communication means 103 sends and receives data to and from mobile data communication means 101. Information storing means 104 stores data to be sent to mobile data communication means 101. Information controlling means 105 controls information stored in information storing means 104 and data sent to and received from data communication means 103. An area 106 is an indicated area for restricting the locations that services can be provided to.

A section 107 and a section 108 are sections of mobile data communication means 101. Information displaying means 107 displays text and images. Operating means 107 allows operations to be performed such as making selections from menus displayed on information displaying means 107. Mobile data communication means 101 is a mobile communication means such as a mobile phone, a mobile information terminal, or a notebook PC. The user 102 uses operating means 108 to perform operations interactively according to displays on information displaying means 107. Mobile data communication means 101 according to this embodiment is equipped with a browser (viewing software) for browsing files such as HTML (Hypertext Markup Language) files located on an Internet WWW server. By using this browser, service screens and the like provided by information provider services according to specific areas as described later can be displayed on information displaying means 107.

Data communication means 103 is a wireless communication means for a public network. This data communication means 103 includes: a BS (Base Station) 109, a BSC (Base Station Controller) 110, an IWF (Inter-working Function) 111, a router 112, a gateway 113, and an IP (Internet Protocol) network.

Mobile data communication means 101 communicates with the BS 109 and connects to the IP network 114 via the BSC 110, the IWF 111, the router 112, and the gateway 113. Information controlling means 105 is also connected to the IP network 114. Mobile data communication means 101 accesses information controlling means 105 via the IP network 114. Also, other Internet information can be accessed via the IP network 114.

Retrieval of position information by mobile data communication means 101 is performed using widely known technology. For example, position information can be obtained by communication with a GPS (Global Positioning System) can be performed or, as described in Japanese laid-open patent publication number Hei 7-111675, by measuring the distance from a base station disposed at a fixed position. It would be preferable for the position information referred to here to be highly precise position information, e.g., indicated by detailed latitude and longitude measurements, rather than information that simply indicates whether mobile data communication means 101 is within the area of a specific mobile phone base station. Obtaining highly precise position information allows information to be provided in a finely differentiated manner according to finely partitioned areas.

Next, an example of how this embodiment can be implemented in a guide service for a zoo will be described using FIG. 2 through FIG. 5.

FIG. 2 shows sample screens displayed on information displaying means 107. For example, when the user 102 goes to the elephant display and accesses the zoo guide service using mobile data communication means 101, a menu screen 201 is displayed on information displaying means 107. One method for accessing the zoo guide service can be, for example, printing a URL (Uniform Resource Locator) on the entry ticket or a pamphlet so that the user 102 can enter the URL. Next, a method for accessing the guide service when mobile data communication means 101 is equipped with a lookup table that associates position information and specific area information, thus allowing mobile data communication means 101 to detect when it is within the zoo guide service availability area. The specific area information referred to here is information about the type of the specific area and information such as the URL of the provider service. In this case, the user 102 automatically accesses the zoo guide service without entering an access destination, e.g., a URL. Alternatively, information indicating that the zoo guide service is available can be displayed on information displaying means 107, after which the user 102 can issue an instruction to access the zoo guide service without entering an access destination such as a URL. Also, it would be possible to have the zoo guide service provider detect when mobile data communication means 101 is within the zoo guide service availability range so that a guide or an indication that the guide is available can be shown to the user 102 automatically.

In FIG. 2, the top of the screen 201 shows a menu for information relating to the elephants currently being viewed. This is possible because the zoo guide service provider has received position information sent from mobile data communication means 101 and is aware that the user is at the elephant display. From here, if the user 102 operates operating means 108 and selects “1. Animal information (elephants)”, a screen 202 is displayed on information displaying means 107. A menu is then displayed with options such as fixed information relating to elephants (“1. Facts about elephants” in the figure) and real-time information (“2. How they are doing today”). If the user 102 selects “2. How they are doing today”, a screen 203 is displayed on information displaying means 107. If the user 102 moves from the elephant display to the panda display, a screen 204 is displayed on information displaying means 107. The top menu option then changes to indicate panda information.

In a screen 203 in FIG. 2, how the elephants are doing today is described using text and images, but it would also be possible to play back audio, video, or the like. Also, a hierarchical menu structure such as the one shown in the screen 102 through the screen 203 is not a requirement, and it would also be possible to have the screen 203 displayed first.

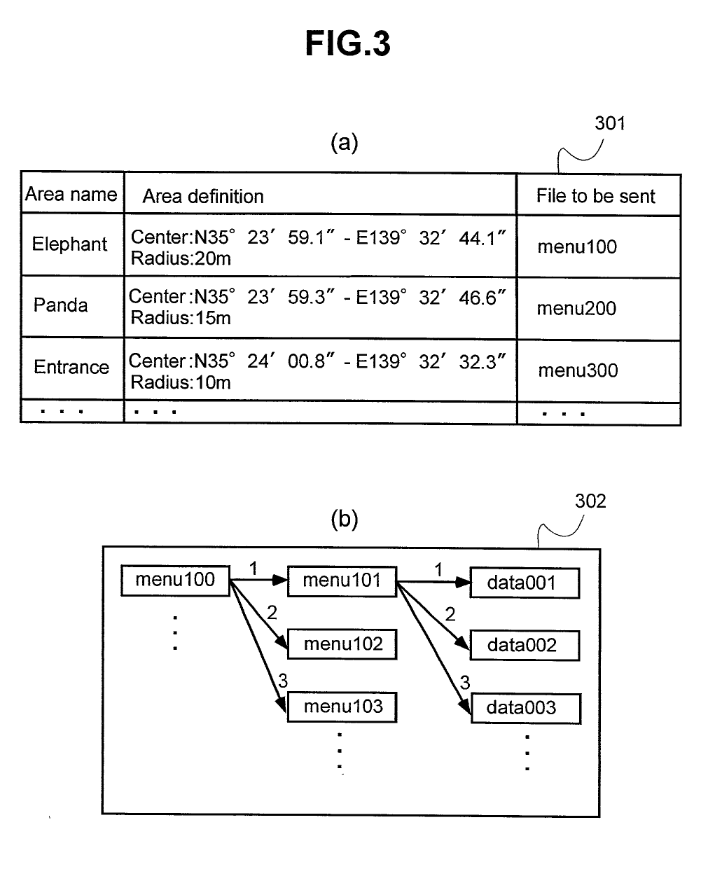

FIG. 3 shows a sample data format stored in information storing means 104. Information storing means 104 stores an area definition table 301 in which position information for arbitrarily defined areas 106 are stored in association with information files to be distributed to the areas 106. Also, information storing means 104 stores file groups 302 containing information to be distributed. It would be preferable for the information distribution files to be written in a language that allows access destinations to be defined, e.g., HTML. However, the files are not restricted to this format and other formats can be used. Also, the files can be image, video, or audio files rather than text files.

For example, in the zoo guide service, the areas 106 can be defined as animal display areas and stored in the area definition table 301 using latitudes and longitudes. Information distribution files are then stored in association with the defined areas 106. In FIG. 3(a), area names are assigned to the areas 106, and position information for the areas 106 are defined in the area definition. In the area definitions, “Center” refers to the latitude and longitude of the central point, with N indicating northern latitude and E indicating eastern longitude. “Radius” indicates the distance from the central point. Thus, the area name for the elephant display area is defined as “elephant”, and the elephant area is an area with a radius of 20 m from a central point at N 35 deg 23′ 59.1″ and E 139 deg 32′ 44.1″. The information file to be sent for the elephant area is “menu100”. The area name for the panda display area is defined as “panda”, and the panda area is an area with a radius of 15 m from a central point at N 35 deg 23′ 59.3″ and E 139 deg 32′ 46.6″. The information file to be sent for the panda area is “menu200”.

FIG. 3(b) shows a portion of the associations in the file groups 302 stored in information storing means 104. In FIG. 3(b), access destination files defined for menu 100 include menu101, menu102, and menu103. The numbers above the arrows indicate the menu numbers in menu 100. Thus, menu101 is associated with option “1” in menu100. Similarly, access destinations defined for menu101 include data001, data002, and data003.

The locations (areas) to be defined do not have to be animal exhibit areas and can be sites such as the zoo entrance and concession stands. Also, circular areas are defined here using latitude, longitude, and radius, but other methods for defining areas can be used. For example, rectangular areas can be defined using the latitudes and longitudes for the upper left and lower right corner points.

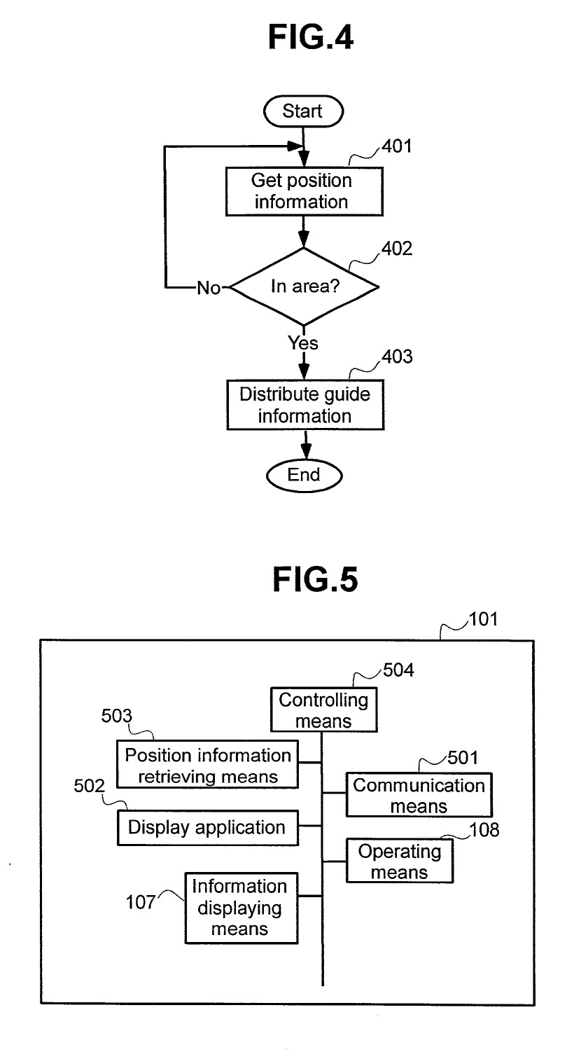

Next, the operations performed by information controlling means 105 will be described using FIG. 4. FIG. 4 is a flowchart showing the flow of operations performed by information controlling means 105 when mobile data communication means 101 receives information after it has been moved.

Mobile data communication means 101 accesses information controlling means 105 via data communication means 103. Information controlling means 105 receives position information from mobile data communication means 101 (step 401). Based on this, information controlling means 105 determines whether the position of mobile data communication means 101 is within an area defined by the area definition table 301 (step 402). If, for example, the position of mobile data communication means 101 is in the elephant area, information controlling means 105 reads the menu100 file defined for the elephant area in the area definition table 301 from information storing means 104. The menu100 file is then sent to mobile data communication means 101 via data communication means 103 (step 403). As a result, the screen 201 from FIG. 2 is displayed on information displaying means 107.

If the user 102 selects “1. Animal information (elephants),” the selected number is sent from mobile data communication means 101 to information controlling means 105 via data communication means 103. Information controlling means 105 reads menu101, which is the access destination “1” defined in menu100, from information storing means 104 and sends menu101 to mobile data communication means 101 via data communication means 103. The menu screen 202 from FIG. 2 is then displayed on information displaying means 107. Next, when “2. How they are doing today” is selected by the user 102, information controlling means 105 reads data002, which is the access destination “2” defined in menu101, from information storing means 104 and sends data002 via data communication means 103. The menu screen 203 from FIG. 2 is then displayed on information displaying means 107.

If the user 102 moves, information controlling means 105 receives position information sent from mobile data communication means 101, thus determining the end position of mobile data communication means 101 (the user). Mobile data communication means 101 can, for example, send the position information at predetermined intervals. If the position of mobile data communication means 101 is, for example, in the panda area, menu200, which is defined for the panda area, is read from information controlling means 105 and menu200 is sent via data communication means 103. The menu screen 204 from FIG. 2 is then displayed on information displaying means 107.

Next, the operations performed by mobile data communication means 101 will be described using FIG. 5. FIG. 5 is a block diagram showing part of the internal structure of mobile data communication means 101. Elements that are identical to those from FIG. 1 are assigned the same numerals.

Communication means 501 provides communication of data to and from data communication means 103. A display application 502 is used to display received information on information displaying means 107. Position information retrieving means 503 retrieves the current position information of mobile data communication means 101. Controlling means 504 provides overall control for mobile data communication means 101.

When the user 102 uses operating means 108 to access information controlling means 105, controlling means 504 retrieves the current position information from position information retrieving means 503. Then, controlling means 504 sends this position information to communication means 501 along with the URL entered by the user 102 into operating means 108, the identification ID of mobile data communication means 101, and the like. Also, when information sent from information controlling means 105 is received by communication means 501, controlling means 504 uses the display application 502 to display the received information on information displaying means 107. If the user 102 makes a menu selection or the like using operating means 108, controlling means 504 sends the user entry using communication means 501.

Also, after accessing information controlling means 105, controlling means 504 obtains the current position information at fixed intervals from position information retrieving means 503 and sends this current position information to information controlling means 105 at fixed intervals using communication means 501. As a result, information controlling means 105 is able to track the current position of mobile data communication means 101 in roughly real time. When the user 102 moves outside of an area defined by the area definition table 301, information controlling means 105 sends information defined for the destination area. At this point, even if there is no input from operating means 108, controlling means 504 passes on the received information to the display application 502 to be displayed on information displaying means 107.

The above description presents an example in which, when the user moves, displaying of the information defined for the destination area is mandatory. Other methods can be used, however. For example, information defined for the destination area can be displayed only if the user 102 uses operating means 108 to accept displaying of new information. This eliminates the annoyance of having information that the user is not interested in automatically displayed.

Also, in the above description, information controlling means 105 determines whether the position of mobile data communication means 101 is within a defined area. However, this determination can be performed by mobile data communication means 101 instead. In this case, mobile data communication means 101 would download and store a lookup table that associates specific area information (information about types of specific areas, URLs for provided services, and the like) with position information. Mobile data communication means 101 can be set up so that the lookup table is automatically erased after a fixed time has elapsed or if it has not been accessed for a fixed period of time.

If controlling means 504 of mobile data communication means 101 determines that it is within a specific area that can receive a data distribution service, information indicating that it is in the specific area is displayed on information displaying means 107. This display can be used to allow the user to indicate whether or not the data distribution service, e.g., the zoo guide service, is to be accessed. If access is desired, the user indicates this with operating means 108, allowing the data distribution service to be accessed without manually entering a URL. The user is also able to enter a URL manually to access the service. If mobile data communication means 101 is to determine whether it is in an area or not, the user 102 operating mobile data communication means 101 chooses whether or not to notify other parties with the current position of mobile data communication means 101. This provides privacy of the position information of the user 102.

As described previously, access to the data distribution service can also take place automatically and unconditionally when mobile data communication means 101 determines that it is in an area capable of receiving the data distribution service. If mobile data communication means 101 is to determine whether or not it is in a specific (defined) area, detailed position information can be sent from mobile data communication means 101 to notify information controlling means 105 that it is in the area. Alternatively, it can simply send information indicating that it is in the area to information controlling means 105.

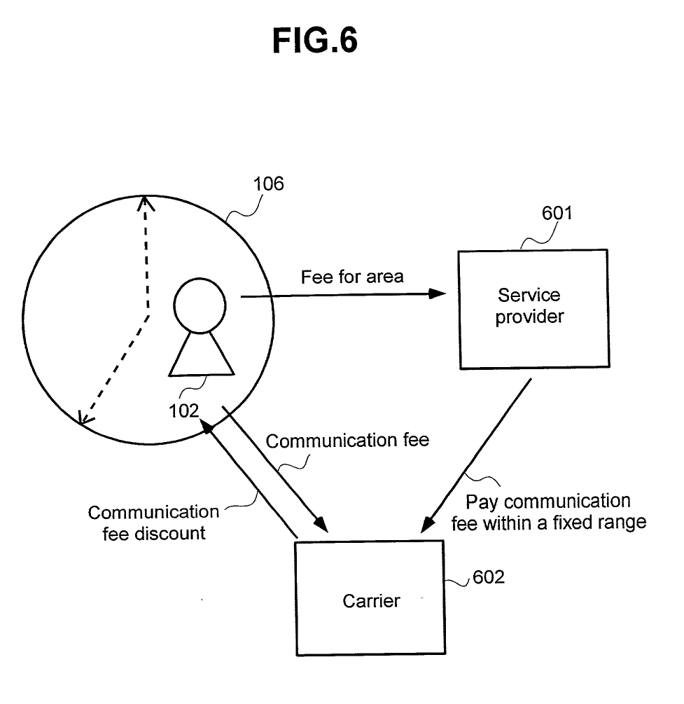

FIG. 6 shows an example of how this embodiment can be implemented in a billing system. A service provider 601 provides a data distribution service. In this case, the provider is a zoo. A carrier 602, e.g., a mobile phone service provider, performs billing and collection of communication fees for communications accessed by the mobile data communication means 101.

The user 102 pays the entry fee, i.e., the fee paid to the zoo, to enter the zoo and uses the zoo guide service. The zoo, i.e., the service provider 601, allocates a portion of the entry fee paid by the user 102 for communication fees generated when the user 102 uses the guide service. For example, communication fees are paid by setting up time limits and fee caps. For example, the service provider 601, i.e., the zoo, can allocate up to 10% of the entry fee toward communication fees paid to the carrier 602 on behalf of the user. If the user 102 exceeds this limit, a warning message is sent, and the user will be responsible for subsequent communication fees. Thus, the service provider 601 is equipped with means for measuring the communication time used by mobile data communication means 101 for accessing the guide service. Also, the service provider 601 is equipped with means for sending the carrier 602 of the identification ID of mobile data communication means 101 and informing the carrier 602 that the fees for the predetermined time's worth of communication fees generated in the current communication will be paid by the service provider 601 on behalf of the user 102.

Also, by setting up toll-free access that is valid only within a predetermined data distribution service area, i.e., within the zoo, the service provider 601 can be responsible for the communication fees that would otherwise be charged to the user 102. In this case, the service provider 601 would be equipped with means for receiving toll-free access from within a predetermined communication fee range (e.g., a range in which communication fees are up to 10% of the entry fee). Whether or not mobile data communication means 101 is located within the zoo or not can be easily determined by the position information notification from the mobile data communication means 101.

In this description, this embodiment is implemented for a guide service in a zoo, but it can also be implemented for other sites such as aquariums, tourist spots, museums, department stores, shopping areas, and the like.

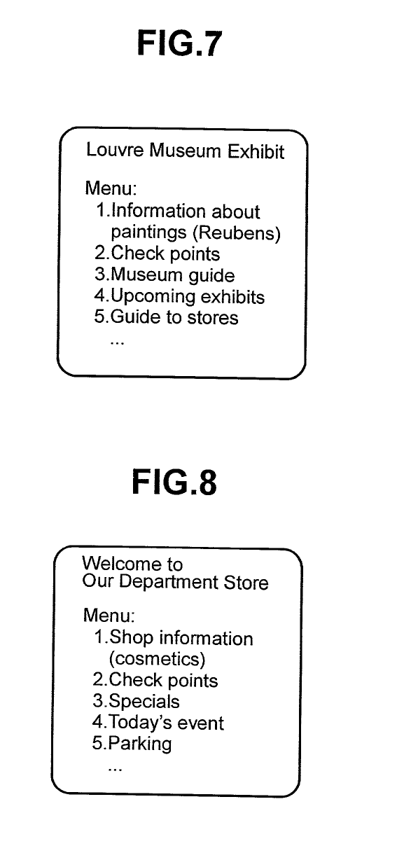

FIG. 7 shows a sample screen displayed on information displaying means 107 when this embodiment is implemented for an art museum. FIG. 7 corresponds to the display 201 from FIG. 2, and the first option in the menu is for information about an exhibit.

FIG. 8 shows a sample screen displayed on information displaying means 107 when this embodiment is implemented for a department store. FIG. 8 corresponds to the display 201 from FIG. 2, and the first option in the menu is for information about a merchandise stand or store.

In the embodiment described above, information can be provided to a user at a specific location. This allows information appropriate for the location to be distributed in real time. Also, mobile data communication means 101 retrieves highly precise position information and sends this position information to the service provider. This allows finely differentiated information services to be provided based on finely partitioned areas. Also, since specific locations are involved, the service provider can allocate a portion of the fee paid by the user to the service provider for the fees involved in receiving the service. Also, if the users are carrying mobile data communication means 101, information can be distributed to any number of users. This allows individual users to freely access information.

The information stored in information storing means 104 does not have to be guide information. General music data, image data, text data, and the like can also be stored. For example, services can be offered such as one free song download for a user 102 at an area 106.

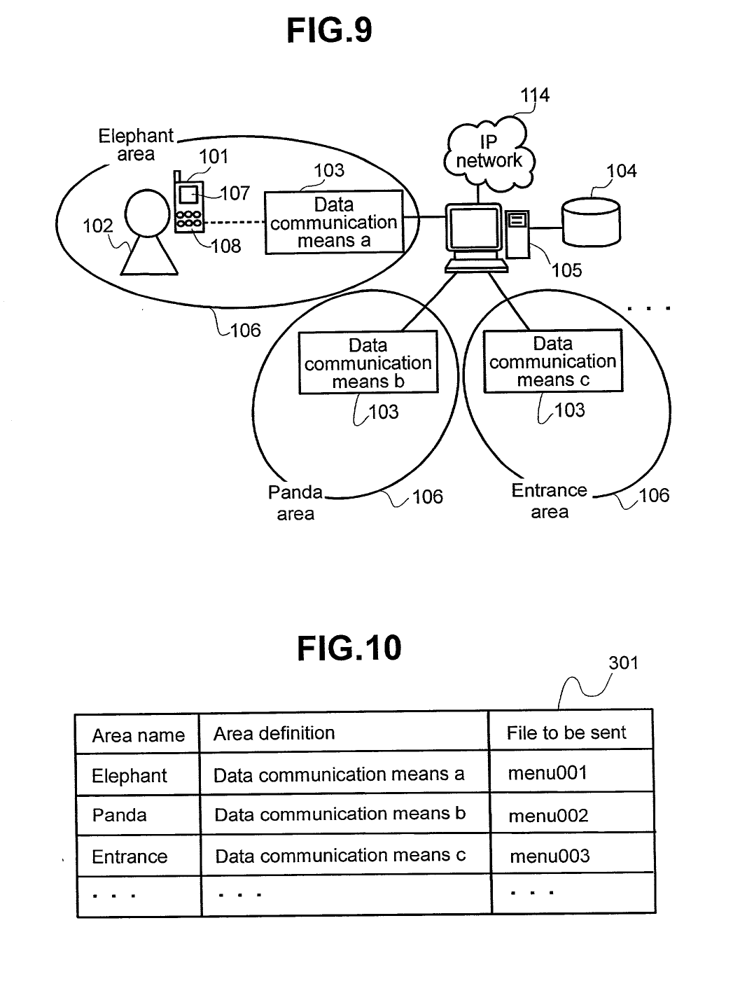

Next, a second embodiment of the present invention will be described. FIG. 9 is a drawing showing the structure of a data distribution system according to the second embodiment of the present invention. This embodiment presents an example of a data distribution service provided through short-range wireless communications.

In FIG. 9, data communication means 103 is a short-range communication means. A representative example would be a means capable of performing high-volume data communications over short ranges of approximately 10 m using spread-spectrum communications in the 2.4 GHz band. In the embodiment shown in FIG. 9, it would be preferable for mobile data communication means 101 to be equipped with a similar short-range communication means for sending and receiving data to and from data communication means 103. However, the present invention is not restricted to this and any means capable of sending and receiving data to and from data communication means 103 can be used. Information controlling means 105 is also connected to the IP network 114 independent from data communication means 103. As a result, Internet information obtainable through the IP network 114 can be sent to mobile data communication means 101 via data communication means 103 in addition to the information stored in information storing means 104.

When short-range wireless communication is used, the areas 106 are defined by the range in which communication is possible through short-range wireless communication means, and mobile data communication means 101 determines that it is in an area when it receives data from short-range wireless communication means. If there are multiple areas, each area is set up with short-range wireless communication means. In this case, information storing means 104 stores the area definition table 301, in which short-range wireless communication means are associated with information files to be distributed by the corresponding short-range wireless means, as shown in FIG. 10, for example. To over wider areas, multiple short-range wireless communication means may be installed in a single area. Also, different information controlling means 105 and information storing means 104 can be installed for each short-range wireless communication means. In this case, short-range wireless communication means can use optical means such as infrared light.

With this embodiment as described above, information distribution can be restricted to the range in which short-range communication means can communicate without requiring areas to be specifically defined. Also, no communication fees are required for data communication between data communication means 103, which serves as short-range communication means, and mobile data communication means 101. Thus, a free data distribution service can be easily provided to users without the need for setting up special billing systems.

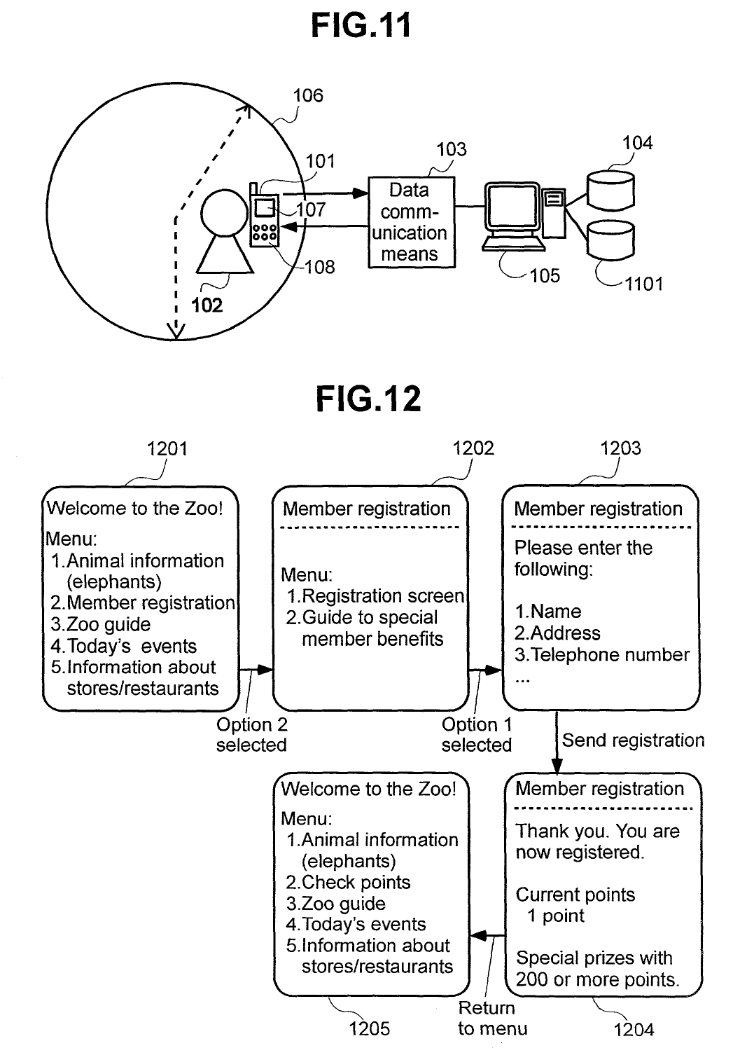

Next, a third embodiment of the present invention will be described. FIG. 11 shows the structure of a data distribution system according to the third embodiment of the present invention. In this figure, elements identical to those from FIG. 1 are assigned the same numerals. User information storing means 1101 stores personal information of the user 102.

In the embodiment shown in FIG. 11, information controlling means 105 receives the user's personal information from mobile data communication means 101 and stores it in user information storing means 1101.

FIG. 12 is a drawing for the purpose of describing how information controlling means 105 receives user information from mobile data communication means 101. Screen 1201 through screen 1204 are examples of screens displayed on information displaying means 107. Rather than receiving users'0 personal information, the example shown in FIG. 12 has users register as members, with special benefits being offered based on points accumulated each time the service is used.

The first screen 1201 is the same as the screen 201 from FIG. 2. The second menu option in the screen 1201 is a “Member registration” menu option for registering personal information. The screen 1202 is displayed when the user 102 selects “Member registration” from the screen 1201. The screen 1202 displays a menu option for performing the actual registration and a menu option to view a guide describing the special benefits that are offered when a user registers. Also, a menu option can be added to the screen 1202 for displaying promotional material for encouraging user's to register as members. If the user 102 selects the “Registration screen” menu option from the screen 1202, the screen 1203 is displayed. The screen 1203 is the screen for actually performing registration. The user 102 enters name, address, and the like and registers. Mobile data communication means 101 then sends the registration contents entered by the user 102 along with a terminal ID. The terminal ID is a unique identification number for mobile data communication means 101 (e.g., a telephone number). Information controlling means 105 then stores the personal information of the user 102 and the terminal ID of mobile data communication means 101 into user information storing means 1101.

When registration is completed, the screen 1204 is displayed to indicate that registration has been completed. The screen 1204 includes point services for special benefits to registered members, and the user 102 will be notified when the first point 1 is added. Furthermore, information can be displayed to indicate the special benefits that are available when a point is added. When the user 102 returns to the top menu after member registration, the screen 1205 is displayed, with the second “Member registration” menu option replaced with a “Check points” menu option available only to registered users. The menu display in the screen 1201 is not required. Also, the terminal ID can be a member number issued when the user registers for the zoo.

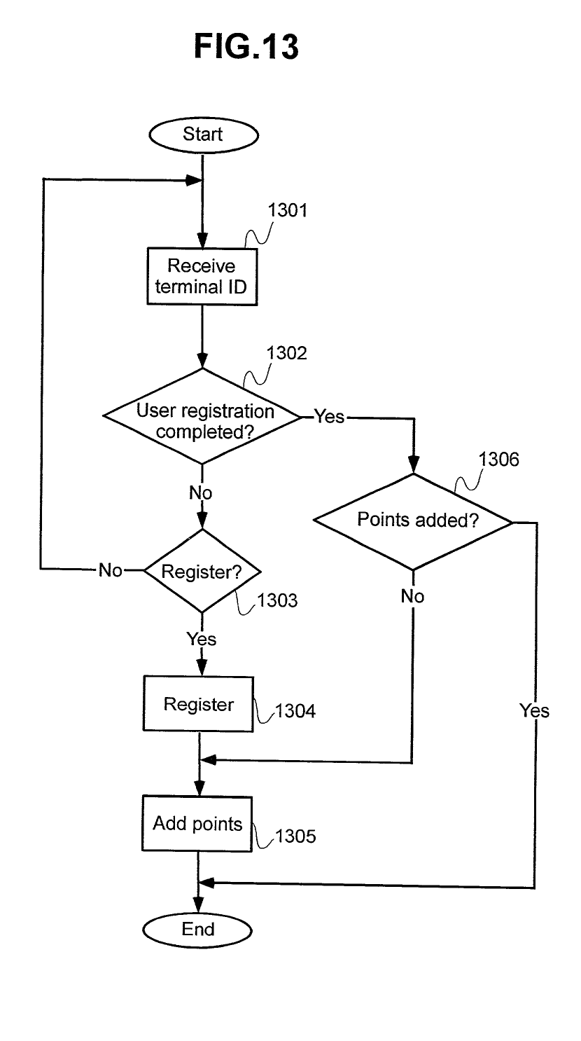

FIG. 13 is a flowchart showing the flow of operations performed by information controlling means 105 from when information is distributed to when a point is added.

First, information controlling means 105 receives a terminal ID from mobile data communication means 101 (step 1301). Next, information controlling means 105 compares the received terminal ID with the terminal IDs stored in user information storing means 1101 and determines whether registration has been completed or not (step 1302). If the terminal ID of mobile data communication means 101 has not been registered, information controlling means 105 waits for registration actions to be performed (step 1303). When registration operations are received from mobile data communication means 101, information controlling means 105 stores the terminal ID of mobile data communication means 101 and the received registration contents to user information storing means 1101 (step 1304), and a point is added (step 1305). Points are also stored in user information storing means 1101 along with user information. If registration had been performed at step 1302, the user information stored in user information storing means 1101 is looked up and a determination is made as to whether a point has already been added or not (step 1306). If a point has not been added, a point is added and stored in user information storing means (step 1305).

For example, a point is to be added for mobile data communication means 101 accessing the information in the screen 203 from FIG. 2. It would be preferable to provide a restriction that limits the number of point additions for the same area in a single day to one. Also, prizes, discount services, or the like can be offered to users who have a certain number of points or more, and information displaying means 107 can be used to indicate to the user that there are enough points to receive this type of benefit.

With this embodiment as described above, users' personal information can be managed and services such as adding points can be provided. As a result, users can collect points and receive special benefits, and the provider of the service can receive more visitors.

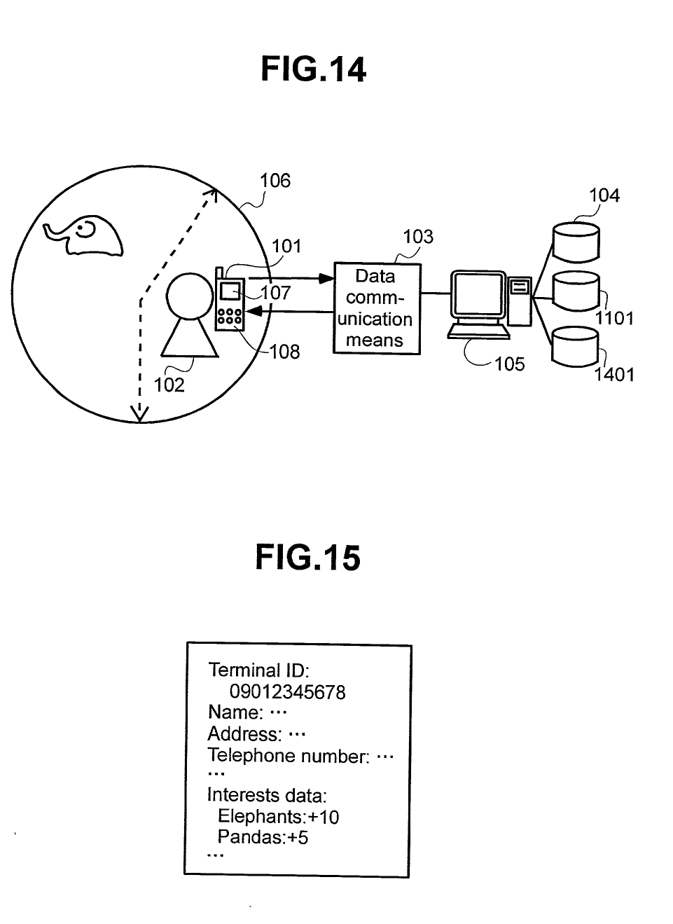

Next, a fourth embodiment of the present invention will be described. FIG. 14 shows the structure of a data distribution system according to a fourth embodiment of the present invention. In this figure, elements identical to those from FIG. 1 or FIG. 11 are assigned the same numerals. Advertisement information storing means 1401 stores preferential treatment information, advertising information, and the like that are used when distributing information to the users stored in user information storing means 1101.

For example, when this embodiment is implemented in a data distribution service in a zoo as in the first embodiment, advertisement information storing means 1401 will store advertising information such as upcoming event information and preferential discount information. Information controlling means 105 reads advertisement information from advertisement information storing means 1401 and sends it to the users stored in user information storing means 1101. In this operation, there are no restrictions regarding the position of mobile data communication means 101 to which the advertisement information is sent. Also, there are no restrictions on transmission time. For example, sending advertisement information a week after a visit to the zoo or the like can be more effective.

If data communication means 103 is short-range wireless communication means, second data communication means (e.g., wireless communication means for a public network) is used to send advertisement information. The other data communication means can be used to send the information stored in information storing means 104 and advertisement information stored in advertisement information storing means 1401. Also, this information can be sent using a method other than through mobile data communication means 101 such as through the postal service or e-mail.

Also, second information controlling means for controlling advertising information can be provided so that information can be controlled using information controlling means other than the information stored in information storing means 104 and advertisement information storing means 1401.

With this embodiment as described above, advertisement information can be sent to users. As a result, users can obtain information about upcoming events and special discounts. For the service provider, this means that users will be encouraged to return.

Next, a data distribution system according to a fifth embodiment will be described. The structure of the system in this embodiment is similar to that of the fourth embodiment from FIG. 14.

FIG. 15 shows an example of user information stored in user information storing means 1101. In addition to personal information registered by the user such as name and address, the user information also includes information about accumulated points and user interests, as shown in FIG. 15. FIG. 15 shows an example in which this embodiment is implemented for a guide service in a zoo. Information about users' interests in elephants, pandas, and the like is stored. The figure shows that elephant interest points are +10 and panda interest points are +5, thus indicating that the user is more interested in elephants than pandas.

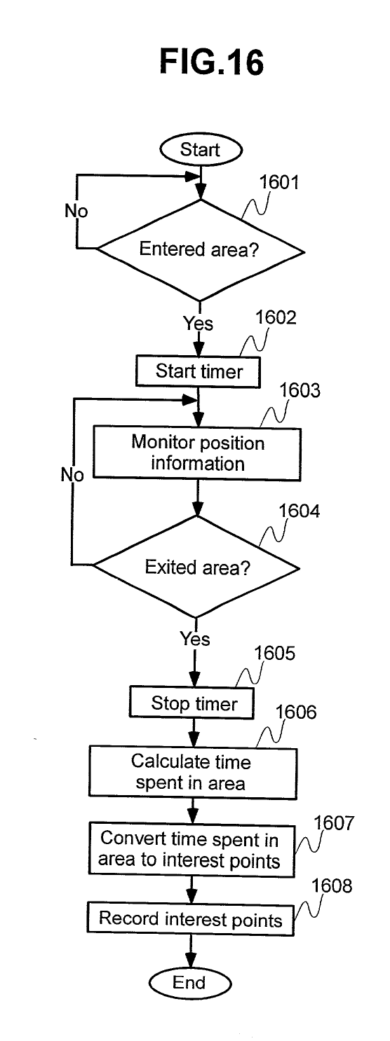

Next, a method for obtaining user interest data will be described using an example where points are based on the amount of time the user spends in an area. FIG. 16 shows the flow of operations performed by information controlling means 105.

First, if mobile data communication means 101 with a terminal ID stored in user information storing means 1101 enters the area 106 (step 1601), information controlling means 105 starts a timer (step 1602). Then, information controlling means 105 monitors the position information of mobile data communication means 101 (step 1603). When mobile data communication means 101 goes outside the area 106 (when step 1604 is Yes), the timer is stopped (step 1605). Next, information controlling means 105 uses the timer value to calculate the time during which mobile data communication means 101 stayed in the area 106 (step 1606), and this time is converted into interest points (step 1607). For example, if the user stayed in the elephant area for 10 minutes, each minute counts as one point so that elephant interest points is +10. Finally, information controlling means 105 stores the converted points in user information storing means 1101 (step 1608).

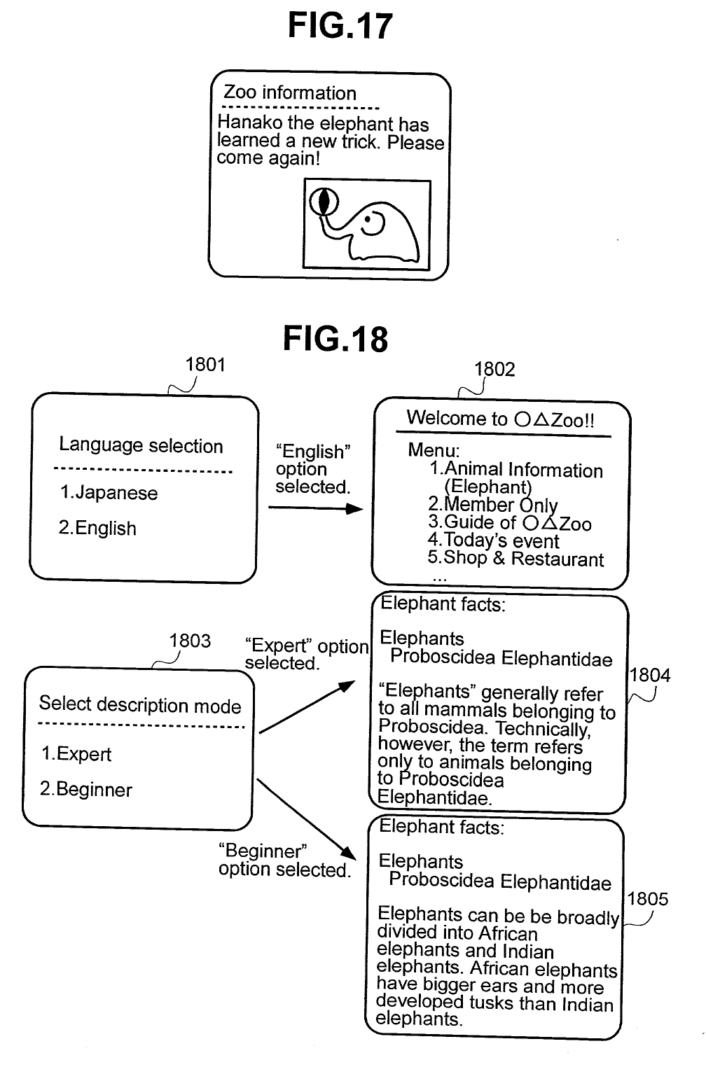

FIG. 17 shows a sample screen displayed on information displaying means 107. This example shows advertisement information to be sent to the user based on the interest data from FIG. 15. Since elephant points are high in the interest data in FIG. 15, advertisement information relating to elephants is sent.

With this embodiment as described above, user interests are converted into points so that advertisement information suited for user interests can be sent. Advertisement information based on interests is more effective than general advertisements and can increase the chances that users will return.

The example in FIG. 17 shows advertisement information, but it would similarly be possible to send information stored in information storing means 104 so that it is suited for user interests.

Also, the method for obtaining data about user interests is not restricted to the method described above. Other methods can be used such as having the user fill out a questionnaire at registration time or through a direct mailing.

Next, a sixth embodiment of the present invention will be described. FIG. 18 shows sample screens displayed on information displaying means 107 of mobile data communication means 101 in an information distribution system according to this embodiment.

In FIG. 18, a screen 1801 is a screen for selecting the language of the information to be received from information controlling means 105. If “English” is selected form the screen 1801, information will be displayed in English, as shown in a screen 1802.

A screen 1803 is a screen for selecting an information mode for information to be received from information controlling means 105. For example, if this embodiment is implemented for a guide service in a zoo, the user can choose to have animals described at either an expert level or a beginner level. If expert-level information is selected, expert-level information is displayed, as in a screen 1804. If beginner-level information is selected, a beginner-level description that can be understood by elementary school students is displayed, as shown in a screen 1805.

The screen 1801 and the screen 1803 can be displayed when the user 102 first accesses information controlling means 105. Alternatively, they can displayed as menu options from other screens.

In the example shown in FIG. 18, the user is able to select language and information mode. Alternatively, information controlling means 105 can send information suited for the user based on the user information stored in user information storing means 1101.

As described above, this embodiment allows the language and mode of the information to be selected. This allows information suited for the user to be sent.

As described above, the present invention allows information to be distributed to a user at a specific location. Thus, information suited for the location can be distributed to the user real-time. Also, mobile data communication means can notify the service provider with highly precise position information. This allows finely differentiated information to be provided based on finely partitioned areas. Also, the present invention allows services to be provided such as having the service provider bear the fees involved in service reception using the entry fee or the like paid by the user to the service provider. Also, since information can be distributed to any number of users as long as they are carrying mobile data communication means, individual users can freely operate the information in an independent manner.

Also, since user's personal information can be obtained, special benefits such as point services can be offered. This allows advertisement information to be sent to users so that they are encouraged to return.

Also, user interests can be surveyed. This allows information suited for the user to be distributed.

We claim:

1. A data distribution system communicating with a mobile data communication device capable of obtaining current position information indicating a current position, comprising:
a data sender/receiver which sends and receives data to and from said mobile data communication device;
a information memory which stores area position information indicating a position of a specific area and information associated with said specific area;
a discriminater which discriminates whether or not said mobile data communication device is in said specific area based on said current position information sent from said mobile data communication device; and
a controller which controls providing control so that, in case said mobile data communication device is located in said specific area, information associated with said specific area is sent to said mobile data communication device via said data sender/receiver.

2. A data distribution system communicating with a mobile data communication device capable of obtaining current position information indicating a current position, comprising:
data communication means sending and receiving data to and from said mobile data communication device;
means for storing information storing area position information indicating a position of a specific area and information associated with said specific area; and
means for controlling said data communication means so that, in case said data communication means receives information indicating that said mobile data communication device is in said specific area, information associated with said specific area is sent to said mobile data communication device.

3. The data distribution system according to claim 2, wherein said mobile data communication device includes: a retrieving module retrieving position information indicating a current position; a determining module determining whether or not said current position is in said specific area; a transmitting module transmitting to said data communication means information indicating that said data communication device is in said specific area; and a receiving module receiving information associated with said specific area sent from said data communication means.

4. A data distribution system communicating with short-range wireless communication means communicating wirelessly with a device over a short range, comprising:
a mobile data communication device which sends and receives data to and from said short-range wireless communication means;
a memory which stores information sent to said mobile data communication device; and
a controller which controls providing control so that data from said mobile data communication device is received via said short-range wireless communication means, and data stored in said information storing means is sent to a mobile data communication device located within a range in which data communication is possible via said short-range wireless communication means.

5. The data distribution system according to claim 1 wherein:
said information memory stores said information associated with said specific area in a plurality of different formats but with equivalent contents;
said mobile data communication device is equipped with a information selector which selects a format for said information stored in said information memory; and
said controller controls said data sender/receiver so that said information in said format selected using said information selector is sent to said data communication device.

6. The data distribution system according to claim 5, wherein said information in said plurality of formats is information in a plurality of languages or information with a plurality of levels of difficulty.

7. The data distribution system according to claim 1, further comprising:
a user information memory which stores user information such as an identification ID or a name of said mobile data communication device,
wherein said controller receives said user information from said mobile data communication device via said data sender/receiver and stores said received user information in said user information memory.

8. The data distribution system according to claim 7, further comprising:
an advertisement information memory which stores preferential treatment information or advertisement information;
wherein said controller controls said data sender/receiver to read said preferential treatment information or advertisement information and send said information to said mobile data communication device.

9. The data distribution system according to claim 7, wherein:
said controller includes means for assigning points to said mobile data communication device each time said mobile data communication device fulfills predetermined conditions and receives said information; and
said points are stored in said user information memory.

10. The data distribution system according to claim 9,
wherein special benefits are provided to an owner of said mobile data communication means based on said points stored in said user information memory.

11. The data distribution system according to claim 8,
wherein said controller obtains interests of an owner of said mobile data communication device and stores said interests in said user information memory.

12. The data distribution system according to claim 11,
wherein said controller reads from said information memory information suited for said user tastes stored in said user information memory and sends said information to said mobile data communication device via said data sender/receiver.

13. The data distribution system according to claim 11, wherein:
said user information memory includes an interest points storing region with associations for each user of a mobile data communication device;
said controller includes means for measuring time spent in said specific area based on said position information received from said mobile data communication device, converting said time to interest points, and adding said interest points to said interest points storing region.

14. The data distribution system according to claim 11, wherein:
said controller reads information from said advertisement information memory information suited for user interests stored in said user information memory, and sends said information to said mobile data communication device via said data sender/receiver.

15. The data distribution system according to claim 8,
wherein said data sender/receiver includes: first data communication means performing communication operations with said mobile data communication device of data including said position information and said information stored in said information storing means; and second data communication means sending preferential treatment information and advertisement information stored in said advertisement information storing means.

16. The data distribution system according to claim 1, further comprising:
a timer which measures time during which said mobile data communication device communicates with said data sender/receiver within said specific area; and
a informing portion which informs an identification ID of said mobile data communication device and a notification indicating that a predetermined amount of communication fees generated during communication will be paid by a service provider of said data distribution system in place of said owner of said mobile data communication device, said information being sent to a communications provider collecting said communication fees.

17. The data distribution system according to claim 1, further comprising:
an allowing portion which allows toll-free access from said mobile data communication device within said specific area.

18. A mobile data communication device comprising:
a position information obtainer which obtains position information for a current position;
a wireless communicater which performs wireless communication of information including position information obtained by said position information obtainer;
a memory which stores position information for a specific area;
a display portion which displays information; and
a controller which controls said display portion to display information indicating that said mobile data communication device is within said specific area in case a current position obtained by said position information obtainer is within said specific area stored in said memory.

19. A mobile data communication device comprising:
means for obtaining position information for a current position;
wireless communication means performing wireless communication of information including position information obtained by said position information obtaining means;
means for storing position information for a specific area;
means for displaying information; and
means for controlling said wireless communication means to send position information obtained by said position information obtaining means if a current position obtained by said position information obtaining means is within said specific area stored in said information storing means.

20. A mobile data communication device as described in claim 19 wherein:
means for entering whether or not displaying of newly received information is accepted; and
said controlling means controls said information displaying means so that when new information is received through said wireless communication means, information indicating that new information has been received is displayed, and said newly received information is displayed if an acceptance entry is received from said entering means.
